(19) United States
(12) Patent Application Publication
(10) Pub. No.: US 2024/0202333 A1
(43) Pub. Date: Jun. 20, 2024

(54) METHOD AND APPARATUS FOR DISARMING OLE OBJECT IN MS-OOXML

(71) Applicant: SECULETTER CO.,LTD., Seongnam-si, Gyeonggi-do (KR)

(72) Inventor: Jae Young YI, Hwaseong-si, Gyeonggi-do (KR)

(73) Assignee: SECULETTER CO.,LTD., Seongnam-si, Gyeonggi-do (KR)

(21) Appl. No.: 17/780,371

(22) PCT Filed: May 25, 2022
(86) PCT No.: PCT/KR2022/007443

§ 371 Date: May 26, 2022

(51) Int. Cl. G06F 21/56

(52) U.S. Cl. CPC G06F 21/566; G06F 2221/033

(57) ABSTRACT

This specification relates to a method of disarming, by a server, an object linking and embedding (OLE) object in MS-Office Open XML (OOXML). The method may include searching an XML file included in a non-PE file for OLE object elements, searching for a rel file corresponding to the XML file comprising the OLE object element, determining a location of an OLE object file based on the rel file, inspecting whether the OLE object is a disarming target, based on the OLE object file being present at the location of the OLE object file, and performing the disarming of the OLE object based on the OLE object corresponding to the disarming target.

### TECHNICAL FIELD

This specification relates to a method and apparatus for disarming an object linking and embedding (OLE) object in an MS-Office Open XML (OOXML) document.

### BACKGROUND ART

A format of an OOXML document is an XML-based file format that is compressed in a zip form. For example, an MS-OOXML document is used in an MS Office program, such as Spreadsheet, a chart, a presentation, and an MS Word processor.

An OLE object means that data generated by application programs in Windows is organically complied without independently using the data. For example, in Hancom Office, a chart, a formula, or a picture may be inserted into NEO HanShow, and acoustic data or voice data may also be inserted into a corresponding document, if necessary.

An MS-OOXML document may include a file vulnerable to security, such as various installation programs, in an OLE object form. If the included file is unconditionally removed for disarming, a problem in that the layout of an office document is wrapped during a disarming operation may frequently occur.

### DISCLOSURE

### Technical Problem

Various embodiments are directed to proposing a method of performing the disarming of an OLE object so that the layout of an MS-OOXML document is not changed.

Technical objects be to achieved by this specification are not limited to the aforementioned object, and the other objects not described above may be evidently understood from the following detailed description of the specification by a person having ordinary knowledge in the art to which this specification pertains.

### Technical Solution

In an embodiment, a method of disarming, by a server, an object linking and embedding (OLE) object in MS-Office Open XML (OOXML) may include searching an XML file included in a non-PE file for OLE object elements, searching for a rel file corresponding to the XML file including the OLE object element, determining a location of an OLE object file based on the rel file, inspecting whether the OLE object is a disarming target, based on the OLE object file being present at the location of the OLE object file, and performing the disarming of the OLE object based on the OLE object corresponding to the disarming target.

Furthermore, the method may further include based on the OLE object being not a disarming target, identifying an image file corresponding to the OLE object by using the rel file, and replacing the OLE object with an image corresponding to the OLE object, based on the image file corresponding to the OLE object.

Furthermore, the rel file may include the OLE object file, and location information of an image file related to the OLE object.

Furthermore, the method may further include terminating the disarming method based on the search for a rel file having failed.

Furthermore, the server may include a contents disarm and reconstruction (CDR) engine configured to perform the disarming and information on a type of object which is capable of being disarmed by the CDR engine.

Furthermore, the inspecting of whether the OLE object is a disarming target may be based on a multipurpose Internet mail extensions (MIME) type included in the OLE object file.

Furthermore, the method may further include removing the OLE object file based on the identification of an image file corresponding to the OLE object having failed.

In another embodiment, a server which disarms an object linking and embedding (OLE) object in MS-Office Open XML (OOXML) may include a communication unit, a memory including a contents disarm and reconstruction (CDR) engine for performing disarming, and a processor configured to functionally control the communication unit and the memory. The processor may search an XML file included in a non-PE file for OLE object elements, may search for a rel file corresponding to the XML file including the OLE object element, may determine a location of an OLE object file based on the rel file, inspect whether the OLE object is a disarming target, based on the OLE object file being present at the location of the OLE object file, and may perform the disarming of the OLE object based on the OLE object corresponding to the disarming target.

### Advantageous Effects

According to an embodiment of this specification, the disarming of an OLE object can be performed so that the layout of an MS-OOXML document is not changed.

Effects which may be obtained in this specification are not limited to the aforementioned effects, and other effects not described above may be evidently understood by a person having ordinary knowledge in the art to which this specification pertains from the following description.

### BRIEF DESCRIPTION OF DRAWINGS

FIG. 1 is a diagram illustrating a server or a client related to this specification.

FIG. 2 is an example of an abnormal input which may be applied to this specification.

FIG. 3 exemplifies a method of disarming an OLE object to which this specification may be applied.

The accompany drawings, which are included as part of the detailed description in order to help understanding of this specification, provide embodiments of this specification and describe the technical characteristics of this specification along with the detailed description.

### MODE FOR INVENTION

Hereinafter, embodiments disclosed in this specification are described in detail with reference to the accompanying drawings. The same or similar element is assigned the same reference numeral regardless of its reference numeral, and a redundant description thereof is omitted. It is to be noted that the suffixes of elements used in the following description, such as a “module” and a “unit”, are assigned or interchangeable with each other by taking into consideration only the ease of writing this specification, but in themselves are not particularly given distinct meanings and roles. Furthermore, in describing an embodiment disclosed in this specification, when it is determined that a detailed description of a related known technology may obscure the subject matter of an embodiment disclosed in this specification, the detailed description will be omitted. Furthermore, it is to be understood that the accompanying drawings are merely intended to make easily understood the embodiments disclosed in this specification, and the technical spirit disclosed in this specification is not restricted by the accompanying drawings and includes all changes, equivalents, and substitutions which fall within the spirit and technical scope of this specification.

Terms including ordinal numbers, such as a “first” and a “second”, may be used to describe various elements, but the elements are not restricted by the terms. The terms are used to only distinguish one element from the other element.

When it is said that one element is “connected” or “coupled” to another element, it should be understood that one element may be directly connected or coupled to another element, but a third element may exist between the two elements. In contrast, when it is described that one element is “directly connected to” or “brought into direct contact with” the other element, it should be understood that a third element does not exist between the two elements.

An expression of the singular number includes an expression of the plural number unless clearly defined otherwise in the context.

In this specification, it is to be understood that a term, such as “include” or “have”, is intended to designate that a characteristic, a number, a step, an operation, an element, a part or a combination of them described in the specification is present, and does not exclude the presence or addition possibility of one or more other characteristics, numbers, steps, operations, elements, parts, or combinations of them in advance.

Furthermore, the term “ . . . unit” used in this specification means a software or hardware element, and the “ . . . unit” performs specific tasks. However, the term “ . . . unit” does not mean that it is limited to software or hardware. The “ . . . unit” may be configured to reside on an addressable storage medium and configured to operate one or more processors. Accordingly, examples of the “ . . . unit” may include elements, such as software elements, object-oriented software elements, class elements, and task elements, processes, functions, attributes, procedures, sub-routines, segments of a program code, drivers, firmware, a microcode, circuitry, data, a database, data structures, tables, and arrays, variables. The functionalities provided in the elements and the “ . . . units” may be combined into fewer elements and “ . . . units”, or may be further separated into additional elements and “ . . . units”.

Furthermore, “ . . . unit” according to an embodiment of this specification may be implemented as a processor and a memory. The term “processor” should be widely interpreted as including a general-purpose processor, a central processing device (CPU), a microprocessor, a digital signal processor (DSP), a controller, a microcontroller, a state machine, etc. In some environments, the “processor” may denote an application-specific semiconductor (ASIC) , a programmable logic device (PLD), a field programmable gate array (FPGA) , etc. The term “processor” may denote a combination of processing devices, such as a combination of a DSP and a microprocessor, a combination of a plurality of microprocessors, a combination of one or more microprocessors combined with a DSP core, or a combination of any other such elements.

The term “memory” should be widely interpreted as including any electronic component capable of storing electronic information. The term “memory” may denote various types of processor-readable media, such as random access memory (RAM), read-only memory (ROM), non-volatile random access memory (NVRAM), programmable read-only memory (PROM), erasable-programmable read-only memory (EPROM), electrically erasable PROM (EEPROM), flash memory, a magnetic or optical data storage device, and registers. If a processor can read information from memory and/or record information on the memory, the memory is said to be in the state in which the memory electronically communicates with the processor. The memory integrated on the processor may state with be in the electronic communication the processor.

The concept of a “non-PE file” used in this specification is opposite to the concept of a PE file or an executable file, and the “non-PE file” means a file that is not autonomously executed. For example, the non-PE file may be a document file such as a PDF file, a Hangul file, or a MS Word file, an image file such as a JPG file, a video file, a JavaScript file, or an HTML file, but the present disclosure is not limited thereto.

Hereinafter, embodiments are described in detail with reference to the accompanying drawings in order for a person having ordinary knowledge in the art to which this specification pertains to easily carry out the embodiments. Furthermore, in order to clearly describe the present disclosure, parts not related to the description may be omitted in the drawings.

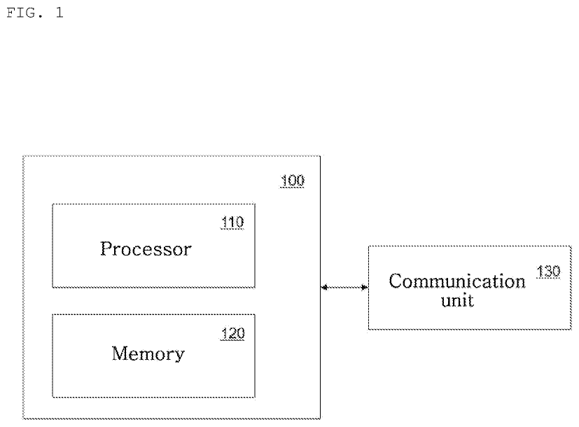

FIG. 1 is a diagram illustrating a server or a client related to this specification.

In this specification, the server (or a cloud server) or the client may include a controller 100 and a communication unit 130. The controller 100 may include a processor 110 and a memory 120. The processor 110 may perform instructions stored in the memory 120. The processor 110 may control the communication unit 130.

The processor 110 may control an operation of the server or the client based on an instruction that is stored in the memory 120. The server or the client may include one processor, or may include a plurality of processors. If the server or the client includes a plurality of processors, at least some of the plurality of processors may be disposed at places that are physically spaced apart from each other. Furthermore, the server or the client is not limited thereto, and may be implemented by using various known methods.

The communication unit 130 may include one or more modules that enable wireless communication between the server or the client and a wireless communication system, between the server or the client and another server or client, or between the server or the client and an external server. Furthermore, the communication unit 110 may include one or more modules that connect the server or the client to one or more networks.

The controller 100 may control at least some of the elements of the server or the client in order to drive an application program that is stored in the memory 120. Moreover, the controller 100 may combine and drive at least two of the elements that are included in the server or the client in order to drive the application program.

In this specification, the server may include a or/and reversing engine a contents disarm and reconstruction (CDR) engine that provides CDR services.

### Reversing Engine

A reversing engine is an analysis/diagnosis engine obtained by automating a reverse engineering (reversing) process for a malicious non-PE file.

For example, the reversing engine may perform the following steps.

1. File analysis: this is a step of analyzing an appearance (e.g., properties, an author, a date created, or a file type) of a non-PE file itself. In this step, whether a non-PE file is malicious may be diagnosed based on only information of the non-PE file itself like a common vaccine program.

2. Static analysis: this is a step of determining whether a non-PE file is normal or malicious by extracting and analyzing data within the non-PE file. In this step, whether a non-PE file is malicious may be diagnosed by extracting internal data suitably for a file structure and comparing and analyzing the extracted data, without executing the non-PE file. This step may be suitable for a macro, the extraction and analysis of a URL, etc.

3. Dynamic analysis: this is a step of determining whether a non-PE file is malicious by analyzing an act of the non-PE file while executing and monitoring the non-PE file. If this step is used, a malicious act using a normal function, such as a macro, a hyperlink, or DDE, can be easily detected.

4. Debugging analysis: this is a step of analyzing vulnerability, exploits, etc. by executing and debugging a non-PE file. This step is suitable for detecting the vulnerability of an application program using a body, a table, a font, a picture, etc. within a document, including a macro, a hyperlink, or DDE.

The reversing engine may include a debugging engine which may be used in debugging analysis. The debugging engine can diagnose vulnerability which occurs in a document input, processing, and output stage by debugging a process of reading a non-PE file. In this case, the vulnerability relates an error, a bug or the like, which occurs when an application program receives an unexpected value in a code (or logic) developed by a developer of the application program. An attacker may execute a malicious document act, such as the denial of service attributable to abnormal termination or the remote execution of a code, through the vulnerability.

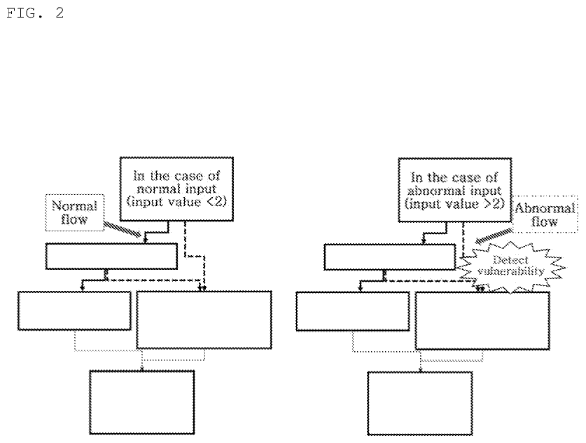

FIG. 2 is an example of an abnormal input which may be applied to this specification.

Referring to FIG. 2, when receiving an abnormal value (e.g., when an input value is greater than 2, that is, a normal range) through a non-PE file, an execution flow of an application program changes into an execution flow not intended by a developer, so that vulnerability may occur. The debugging engine may set a break point at a specific point that is related to the vulnerability by automatically debugging a document reading process, may check the specific value related to the input value, and may diagnose whether the non-PE file is malicious by determining whether the input value is a value that causes the vulnerability.

More specifically, the debugging engine may start debugging by checking the non-PE file and executing the application program for reading the non-PE file. When a module is loaded in the process of reading the non-PE file, the debugging engine may check whether the corresponding module is an analysis target module, and may set the break point at a designated address when the corresponding module is an analysis target.

For example, a malicious non-PE file may have branch points at which an application program is terminated or a flow of the application program branches into a flow in which any malicious act does not occur when a version of the application program or a specific condition, such as an operating system environment, is not satisfied. The server may set a break point at a branch point that is previously analyzed by an analyst and that has such a possibility.

Furthermore, the server may set conditions on which the server may continue to execute the application program without terminating the application program or may induce a flow of the application program into a flow in which a malicious act may occur, in association with a corresponding branch point.

If a process of the application program is stopped at a corresponding break point during the process, the server may perform a step of detecting the occurrence of vulnerability through detection logic and then storing the results of the detection in an analysis report.

The automation reversing engine that is included in the server can diagnose and block a malicious non-PE file through a diagnosis algorithm researched and developed by an analyst, by analyzing the aforementioned steps while automatically performing the aforementioned steps.

### Contents Disarm and Reconstruction (CDR)

A CDR service is a solution that generates a new file by decomposing a non-PE file, removing a malicious file or an unnecessary file from the non-PE file, and making content therein identical with the original as much as possible.

That is, CDR means a service that generates a safe document by disarming and reconstructing content within a document and that provides the safe document to a customer. A disarming target file may include all non-PE files (e.g., a MS Word, Excel, PowerPoint, a Hangul, and a PDF). Disarming target content may be active content (e.g., a macro, a hyperlink, and an OLE object).

In the following embodiments, a case in which a non-PE file is a DOCX file is described as an example, but the present disclosure may be similarly applied to other MS-OOXML documents (e.g., PPTX and XLSX).

### Structure of DOCX Document

Table 1 exemplifies the structure of a file including elements that are related to an OLE Object included in a DOCX document.

TABLE 1

```
. [symbol]
|__ [Content_Types].xml [symbol]
|__ words [symbol]
  |__ document.xml [symbol]
  |__ _rels [symbol]
  |__ |__ document.xml.rels [symbol]
  |__ embeddings [symbol]
  |__ |__ oleObject1.bin [symbol]
  |__ media [symbol]
      |__ image1.emf [symbol]
```

Referring to Table 1, for example, DOCX may include [Content_Types]. xml, oleObject1.bin document.xml.rels, document.xml, and imagel.emf, that is, a media file. The aforementioned files are classified based on information included therein and purposes thereof, but the present disclosure is not limited to such file names.

1) [Content_Types].xml

Table 2 exemplifies the construction of [Content_Types].xml.

```
TABLE 2
<Types xmlns=“http://schemas.openxmlformats.org/package/2006/content-types”>
  <Default
    Extension=“bin”
    ContentType=“application/vnd.openxmlformats-officedocument.oleObject”/>
  <Default
    Extension=“emf”
    ContentType=“image/x-emf”/>
</Types>
```

Referring to Table 2, the extension (e.g., Extension=“bin”) of a file related to an OLE object may be registered with [Content_Types].xml. Furthermore, the extension (e.g., Extension=“emf”) of an image that is used to indicate the OLE object in a document may also be registered with [Content_Types]. xml.

2) oleObject1.bin-OLE Object File

An OLE object enables an application program object written in another file format to be shared. The following exemplifies the OLEObject specification of DOCX.

19.2.2.20 OLEObject (Embedded OLE Object)

A corresponding element specifies an embedded object.

Table 3 exemplifies attributes included in OLEObject. Referring to Table 3, o:OLEObject may indicate actual OLE object information (rId5), and v:imagedata may indicate image information (rId4) for indicating an OLE object in a document.

TABLE 3

| ATTRIBUTES | DESCRIPTION |
|---|---|
| DrawAspect (Embedded | Designate a method of visually representing an embedded object |
| Object | within an application |
| Representation) | [Example : |
| | <o:OLEObject ... DrawAspect=“Content”> |
| | </o:OLEObject> |
| | end example] |
| | The possible values for this attribute are defined by the |
| | ST_OLEDrawAspect simple type (§19.2.3.18). |
| id (Relationship) | Designate an actual OLE object by using standard part |
| Namespace: | relationship lookup |
| .../officeDocument | [Example: |
| /2006/relationships | <o:OLEObject ... r:id=“rId5”> |
| | </o:OLEObject> |
| | end example] |
| | The possible values for this attribute are defined by the |
| | ST_RelationshipId simple type (Part 1, §22.8.2.1) . |
| ObjectID (Unique ID | Designate a unique ID to identify an embedded object |
| for Embedded Object) | [Example: The following markup defines a reference to a linked |
| | object using KParts. The name attribute contains the shared |
| | library that contains the plugin. The item element contains the |
| | name of the plugin. The content type of referred part would |
| | identifies the referenced KParts object. |
| | <oleLinkr:id=“rKp1” progId=“libhtmlvalidatorplugin”> |
| | ... |
| | </oleLink> |
| | The following XML, contained in the target of the relationship |
| | with ID rKp1, defines the KPart object, and follows the kpartgui |
| | DTD: |
| | <!DOCTYPE kpartgui SYSTEM “kpartgui.dtd”> <kpartgui |
| | library=“libhtmlvalidatorplugin” name=“htmlvalidatorplugin” |
| | version=“1” > |
| | <MenuBar> |
| | <Menu_name=“tools”><Text>&amp;Tools</Text> |
| | <Action name=“validatewebpage”/> |
| | </Menu> |
| | </MenuBar> |
| | </kpartgui> |
| | end example] |
| | The possible values for this attribute are defined by the W3C |
| | XML Schema string datatype, |
| ProgID (Object Link | Designate an embedded object server application associated with |
| Identifier) | an embedded object |
| | [Example: |
| | <o:OLEObject ... ProgID=“AVIFile”> |
| | </o:OLEObject> |
| | end example] |
| | The possible values for this attribute are defined by the W3C |
| | XML Schema string datatype. |
| ShapeID | Designate a form associated with an embedded object. A VML form |
| (Embedded Object | provides a visual placeholder of the embedded object, and |
| Shape) | attributes thereof set the ID of a placeholder form. |
| | [Example: |
| | <o:OLEObject ... ShapeID=“_x0000_i1025”> |
| | </o:OLEObject> |
| | end example] |
| | The possible values for this attribute are defined by the W3C |
| | XML Schema string datatype. |
| Type (Embedded Object | Designate the type of embedded object connection. |
| Type) | [Example: |
| | <o:OLEObject ... Type=“Embed”> |
| | </o:OLEObject> |
| | end example] |
| | The possible values for this attribute are defined by the |
| | ST_OLEType simple type (§19.2.3.20). |
| UpdateMode (Update | If a type is a link, designate a method of updating an object |
| Mode for Embedded | with new data (automatically or depending on a user need) |
| Object) | [Example: |
| | <o:OLEObject ... UpdateMode=“Always”> |
| | </o:OLEObject> |
| | end example] |
| | The possible values for this attribute are defined by the |
| | ST_OLEUpdateMode simple type (§19.2.3.21). |

※ Reference: ECMA-376 5th edition 2016/Ecma Office Open XML Part 4-Transitional Migration Features.pdf

3) document.xml.rels

Table 4 exemplifies the construction of document.xml.rels.

```
TABLE 4
<Relationships xmlns=“http://schemas.openxmlformats.org/package/2006/relationships”>
  <Relationship
    Id=“rId4”
    Type=“http://schemas.openxmlformats.org/officeDocument/2006/relationships/image”
    Target=“media/image1.emf”/>
  <Relationship
    Id=“rId5”
    Type=“http://schemas.openxmlformats.org/officeDocument/2006/relationships/oleObje
ct”
    Target=“embeddings/oleObject1.bin”/>
</Relationships>
```

Referring to Table 4, in order to be used in a document, an accurate file name is registered with “.rels.” Another format other than oleObject may be inserted into Type depending on the type of an OLE object. (e.g., package)

4) document.xml

Table 5 exemplifies the construction of document.xml.

```
TABLE 5
<w:object w:dxaOrig=“1401” w:dyaOrig=“831”
w14:anchorId=“3621F7B1”>
  <v:shapetype
      id=“_x0000_t75” coordsize=“21600,21600” o:spt=“75”
      o:preferrelative=“t”
      path=“m@4@5l@4@11@9@11@9@5xe” filled=“f”
      stroked=“f”>
  <v:stroke joinstyle=“miter”/>
  <v:formulas>
    <v:f eqn=“if lineDrawn pixelLineWidth 0”/>
    <v:f eqn=“sum @0 1 0”/>
    <v:f eqn=“sum 0 0 @1”/>
    <v:f eqn=“prod @2 1 2”/>
    <v:f eqn=“prod @3 21600 pixelWidth”/>
    <v:f eqn=“prod @3 21600 pixelHeight”/>
    <v:f eqn=“sum @0 0 1”/>
    <v:f eqn=“prod @6 1 2”/>
    <v:f eqn=“prod @7 21600 pixelWidth”/>
    <v:f eqn=“sum @8 21600 0”/>
    <v:f eqn=“prod @7 21600 pixelHeight”/>
    <v:f eqn=“sum @10 21600 0”/>
  </v:formulas>
  <v:path o:extrusionok=“f” gradientshapeok=“t” o:connecttype=“rect”/>
  <o:lock v:ext=“edit” aspectratio=“t”/>
</v:shapetype>
<v:shape id=“_x0000_i1025” type=“#_x0000_t75”
style=“width:70pt;height:41.5pt”
o:ole=“”>
  < [symbol] -the following element is image information for indicating an OLE
  object -->
  <v:imagedata r:id=“rId4” o:title=“”/>
</v:shape>
< [symbol] -the following element is actual OLE entity information -->
<o:OLEObject
    Type=“Embed”
    ProgID=“Package”
    ShapeID=“_x0000_i1025”
    DrawAspect=“Content”
    ObjectID=“_1682421181”
    r:id=“rId5”/>
</w:object> [symbol]
indicates data missing or illegible when filed
```

Referring to Table 5, document.xml may be an xml file that corresponds to the body of a MS Word document.

Furthermore, a file that forms a pair along with the xml file may be a file in which extension “.rel” is added to the same file name. Through document. xml, in a non-PE file, the body of the MS Word document may be constructed by using related information, such as an object or an image used within the body. Furthermore, in general, the contents of each of a header/footer, footnotes, or endnotes may be constructed in an xml file. In this case, a rel file forming a pair along with the xml file may also be deployed.

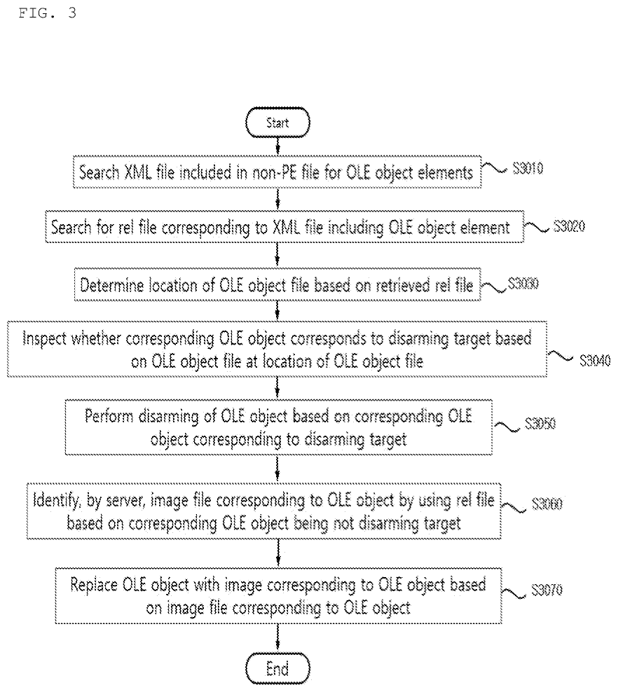

FIG. 3 exemplifies a method of disarming an OLE object to which this specification may be applied.

An embodiment disclosed hereinafter exemplifies a case in which the extension of a non-PE file is DOCX, but may operate in a similar way even in another MS-OOXML document as described above. If another MS-OOXML document is a target of the present embodiment, file names of this specification may be changed into appropriate file names.

Referring to FIG. 3, the server (or the client or the cloud server) may perform the disarming of an OLE object in a non-PE file.

The server searches an XML file included in the non-PE file for OLE object elements (S3010). For example, the server may open all files whose extensions are XML, among files included in the non-PE file, and may fully search whether the OLE object elements are included in the XML file. For example, the server may open document.xml in svg.docx, and may search for o:OLEObject element.

The server searches for a rel file that corresponds to the XML file including the OLE object element (S3020). For example, the rel file may specify the relationship between the non-PE file and a document linked thereto. For example, the server may search whether svg.docx includes a document.xml.rel file.

The rel file may include an OLE object file and an image location for screen display that is related to the OLE object. If the search for a rel file corresponding to the XML file has failed, the server may terminate the disarming task because the non-PE file has been broken or the OLE object has been wrong.

The server determines the location of the OLE object file based on the retrieved rel file (S3030). For example, the server may search for location information (Target) attributes of the OLE object file by finding, in a document.xml.rel file, a relationship element corresponding to an r:id value that has been retrieved through document.xml.

The server inspects whether a corresponding OLE object corresponds to a disarming target, based on an OLE object file at the location of the OLE object file (S3040). For example, the server may inspect whether the corresponding OLE object corresponds to a target which may be disarmed by the server by analyzing the OLE object file. The server may include information on the type of object which may be disarmed by a CDR engine mounted on the server.

More specifically, the server may determine whether the OLE object is a disarming target by identifying a multipurpose Internet mail extensions (MIME) type of OLE object file. The MIME type may indicate a document, a file, or a characteristic and format having a byte vowel. Such an MIME type has been defined and standardized in RFC 6838.2022.4.30 of IETF.

The server performs the disarming of the OLE object based on the OLE object corresponding to the disarming target (S3050). For example, the OLE object may be included in any file. Accordingly, if a file inserted as the OLE object is a document corresponding to the disarming target, the server may replace the OLE object file with the results of the disarming.

More specifically, if the OLE object file has been stored in an OOXML document format, the server may perform the operation from S3010 by using the OLE object file as a non-PE file in order to perform a disarming task on the OLE object file.

If the OLE object file has been stored as a bin extension (e.g., OLE 1.0 or 2.0 format), the server may identify an MIME-type of a corresponding CFB document by undoing the CFB document. If a format of the OLE object file is OOXML, the server may perform the operation from S3010 by using the OLE object file as a non-PE file.

Accordingly, the server may replace an inserted OLE object by replacing the OLE object file with a resulting file of disarming.

The server identifies an image file corresponding to the OLE object by using the rel file based on the OLE object being not a disarming target (S3060).

If an OLE object has been inserted into a non-PE file, whether the non-PE file will be indicated as an icon or whether an original screen of an inserted document will be used without any change may be set. Furthermore, in general, a display image (print) for such setting may be stored in an emf or wmf form.

For example, the server may obtain location information (Target) attributes by searching document.xml for a display image r:id value of the OLE object and searching a document.xml.rel file for a relationship element matched with the corresponding r:id value. If location information is not present or an image file is not present in obtained location information, the server may remove the OLE object file.

The server replaces the OLE object with an image corresponding to the OLE object, based on an image file corresponding to the OLE object (S3070).

For example, there may be provided a function for simultaneously updating a screen even in a document including an OLE object that has been inserted into a non-PE file while opening the document by a double-click and editing the document. Due to such a function, the layout (or arrangement) of the document may not be wrapped only when the same view is provided after the OLE object is inevitably removed when the OLE object is disarmed.

To this end, the server may generate and replace a CFBOLE 1.0 or 2.0 file by using an image for the OLE object. For example, the server may generate an oleObject##.bin file by using an image file corresponding to the OLE object, and may replace the existing file.

The aforementioned present disclosure may be implemented in a medium on which a program has been recorded as a computer-readable code. The computer-readable medium includes all types of recording devices in which data readable by a computer system is stored. Examples of the computer-readable medium include a hard disk drive (HDD), a solid state disk (SSD), a silicon disk drive (SDD), ROM, RAM, CD-ROM, a magnetic tape, a floppy disk, an optical data storage device, and also include an implementation having the form of carrier waves (e.g., transmission through the Internet). Accordingly, the detailed description should not be construed as being limitative, but should be considered to be illustrative from all aspects. The scope of the present disclosure should be determined by reasonable analysis of the attached claims, and all changes within the equivalent scope of the present disclosure are included in the scope of the present disclosure.

Furthermore, although the services and embodiments have been chiefly described, they are only illustrative and are not intended to limit the present disclosure. A person having ordinary knowledge in the art to which the present disclosure pertains may understand that various modifications and applications not illustrated above are possible without departing from the essential characteristics of the present services and embodiments. For example, each of the elements described in the embodiments may be modified and implemented. Furthermore, differences related to such modifications and applications should be construed as belonging to the scope of the present disclosure defined in the appended claims.

1. A method of disarming, by a server, an object linking and embedding (OLE) object in MS-Office Open XML (OOXML), the method comprising:
searching an XML file included in a non-PE file for OLE object elements;
searching for a rel file corresponding to the XML file comprising the OLE object element;
determining a location of an OLE object file based on the rel file;
inspecting whether the OLE object is a disarming target, based on the OLE object file being present at the location of the OLE object file; and
performing the disarming of the OLE object based on the OLE object corresponding to the disarming target.

2. The method of claim 1, further comprising:
based on the OLE object being not a disarming target,
identifying an image file corresponding to the OLE object by using the rel file; and
replacing the OLE object with an image corresponding to the OLE object, based on the image file corresponding to the OLE object.

3. The method of claim 1, wherein the rel file comprises the OLE object file, and location information of an image file related to the OLE object.

4. The method of claim 3, further comprising terminating the disarming method based on the search for a rel file having failed.

5. The method of claim 1, wherein the server comprises:
a contents disarm and reconstruction (CDR) engine configured to perform the disarming, and
information on a type of object which is capable of being disarmed by the CDR engine.

6. The method of claim 5, wherein the inspecting of whether the OLE object is a disarming target is based on a multipurpose Internet mail extensions (MIME) type included in the OLE object file.

7. The method of claim 2, further comprising removing the OLE object file based on the identification of an image file corresponding to the OLE object having failed.

8. A server which disarms an object linking and embedding (OLE) object in MS-Office Open XML (OOXML), the server comprising:
a communication unit;
a memory comprising a contents disarm and reconstruction (CDR) engine for performing disarming; and
a processor configured to functionally control the communication unit and the memory,
wherein the processor is configured to search an XML file included in a non-PE file for OLE object elements, search for a rel file corresponding to the XML file comprising the OLE object element, determine a location of an OLE object file based on the rel file, inspect whether the OLE object is a disarming target, based on the OLE object file being present at the location of the OLE object file, and perform the disarming of the OLE object based on the OLE object corresponding to the disarming target.
